(19) United States
(12) Patent Application Publication
(10) Pub. No.: US 2023/0265294 A1
(43) Pub. Date: Aug. 24, 2023

(54) MARINE COATING FORMULATIONS

(71) Applicant: CALIX LTD., Pymble, New South Wales (AU)

(72) Inventors: Mark Geoffrey Sceats, Pymble (AU); Robert Van Merkestein, Pymble (AU); Adam Vincent, Pymble (AU); Philip Hodgson, Pymble (AU); Andrew Okely, Pymble (AU)

(21) Appl. No.: 18/041,092

(22) PCT Filed: Aug. 11, 2021
(86) PCT No.: PCT/AU2021/050883

§ 371 Date: Feb. 9, 2023

(30) Foreign Application Priority Data
Aug. 12, 2020 (AU) 2020902845

(51) Int. Cl. C09D 5/16; C09D 7/40; C09D 7/61; C09D 5/08

(52) U.S. Cl. CPC C09D 5/1656; C09D 7/69; C09D 7/61; C09D 5/084; C09D 5/1681; C09D 5/1687; C09D 5/1618

(57) ABSTRACT

A formulation for a coating for applications on maritime infrastructure or vessels to inhibit fouling and corrosion that comprises: (a) a nano-active material; and (b) a polymer binder; and (c) additives which include pigments, booster antifoulants, booster anticorrosion materials, solvents, polymerisation activators, viscosity modifiers and fillers, where the nano-active material, the binder and additives provide the coating with the desired most desirable properties of antifoul, anticorrosion, adhesion, and strength, required for the coating application.

### TECHNICAL FIELD

The present invention relates broadly to the formulation and/or a composition of a marine coating. This invention is an extension of previous applications on the use of bio-active magnesium oxide (MgO) powders in coatings, by extending the teaching to consider the most appropriate formulations for applications on static maritime infrastructure, boats and ships.

### BACKGROUND

For the purposes of this invention, marine fouling is a process that starts with the generation of a biofilm by micro-organisms such as diatoms as the primary coloniser, followed by micro- or macro-organisms such as algae or weeds as secondary colonisers, and then followed by macro-organisms such as barnacles and tube worms by tertiary colonisers through their lifecycles from larvae to adults. Marine corrosion is the corrosion of a substrate, generally a metal, by water which may arise from a later stage of fouling or by external impact.

The development of marine coatings to inhibit the growth of fouling of a substrate, as antifouling paints, has a long history, which is inter-connected with the need to inhibit corrosion of the substrate. The substrate many be stationary infrastructure or the hull of a vessel, usually steel or aluminium, including surfaces exposed to sea spray.

A typical marine coating is generally composed of a polymer as the paint binder, a volatile solvent which dries to form the base material of the coating matrix, antifouling biocides to control the growth of foulants, a variety of additives such as thixotropic agents, pigments, viscosity modifiers and anti-corrosion additives, with the mix depending on the application. For vessels, the polymer and additives are designed to produce adhesion to the hull, hard coatings, or soft ablative coatings of various types at the water interface. The coating formulations may be applied in layers to manage the different requirements of adhesion and corrosion of the hull, and fouling from the surface. The layer formulations are also designed to deal with impacts that may occur during use to minimise the most undesirable consequences. There have been developed specialised surface coatings, called super-hydrophobic, that claim to inhibit growth and reduce friction. The complexity and cost of recoating vessels and infrastructure is significant, so there is a continuing demand for improved coating formulations that increase the time for recoating.

The use of tributyl tin as the biocide was very effective, but its widespread use was toxic to marine life, and it was banned in 2001 by the International Maritime Organisation in the “International Convention on the Control of Harmful Antifouling Systems on Ships”. In Europe, the EU Regulation No 528/2012, known as the Biocide Product Regulation (BPR) authorizes a limited number of biocides, namely three copper derivatives (copper, copper thiocyanate and dicopper oxide), and five booster biocides (DCOIT, Zineb, copper pyrithione, zinc pyrithione and Tralopyril).

The booster biocides are used to limit the amount of copper, and are usually directed towards limiting the growth of primary and secondary colonisers, whereas the more toxic copper is preferentially used to limit the growth of the tertiary colonisers. It is noted that the copper compounds are effective biocides on all colonisers, and the use of booster biocides is used to limit the overall use of copper. Organic booster biocides have also been developed. Certain copper materials cannot be applied on aluminium hulls because they induce corrosion, so that protection of aluminium hulls requires a layers of primer to prevent such corrosion, and applications of antifouling paints for aluminium hulls often use alternative copper compatible compounds with low mobility to limit corrosion.

There is growing evidence that the copper materials, as toxins, are causing environmental damage. This concern is enhanced by reports of growing resistance of the colonisers to copper. In addition, the risks to the health of workers engaged in removing and applying toxic materials is an additional impost. There is a need to reduce the use of toxic materials in marine coatings.

The need to reduce the copper content was recognised in the literature from the end of the tributyltin era, where it was recognised by experts that the extensive use of copper would begin to harm the sea. The recent growth of resistance is an outcome of the response of all ecosystems to biocides. The development of booster biocides ameliorate the development of resistance, but the resistance will continue to increase. The situation is that copper compounds are the only toxic materials that are sufficiently biocidal to tertiary colonisers, such as barnacles and tube worms, so that proposed regulations to ban such materials is premature until cost effective non-toxic materials are available to inhibit their growth.

The anchoring mechanisms of the tertiary colonisers means that their deep penetration into the coating is inhibited by the bulk concentration of the copper compounds deep within the coating which have not been previously leached near the surface to combat primary and secondary colonisers. The release rate of the copper biocides that kill primary and secondary colonisers is such that the long term effectiveness of the coating is limited by depletion of these toxins. Typically, the biocide is released from a porous surface structure formed by the coating, or the coating is refreshed by ablation of the coating. Ablative coatings are now common, and require recoating on the 1-3 year timeframe, depending on conditions.

It is possible to characterise the development of anti-fouling coatings in terms of the “near” and “far” responses of the coating by the distance from the water/coating interface. In the region near the surface, which evolves over time in ablative coatings, the toxins are leached from the formulation by dissolving in the water that penetrates into the coating through defects and pores. Many of the booster biocides are selected to have inhibitory effects against the primary and secondary colonisers. They, and the copper biocide, kill these through their biocidal action, and it is a matter of time before these surface toxins are depleted and the colonisation takes place. The larvae of the tertiary colonisers accumulates on and near this surface, and they launch tendrils deep into the coating to gain traction. The role of copper deep in the coating inhibits their growth, but attachment is eventually successful and it is only a matter of time before adult tertiary colonisers grow. Routine maintenance is always required to replace the coatings, either because of ablation or from cumulative fouling.

With respect to anti-corrosion coatings, chromium compounds are used on both steel and aluminium. As with tin and copper compounds, chromium is toxic and the same concerns with environmental damage and workforce health abound. There is a need to develop non-toxic anti-corrosion coatings. The use of lanthanum compounds to replace chromium in coatings has emerged as a potential anti-corrosion solution for steel hulls, where the lanthanum from the coating deposits onto a corroding surface to reduce the rate of corrosion from salt. It is assumed herein that galvanic protection of the metals is used.

Another approach has been to develop marine coatings that are sufficiently hydrophobic that the anchoring of the initial biofilm and the colonisers are sufficiently weakly attached that they slough off with minimal turbulence, and ideally under gravity. Such desirable hydrophobic coatings would have the intrinsic property that the drag of the water on a vessel is minimised, and the fuel consumption would be reduced. The concept has been described, for example by Sunder et.al in US2014/0208978 “Super Hydrophobic Coating” and may be applied to coatings which have a high contact angle in water exceeding about 140°. On the basis of hydrodynamics, the ideal superhydrophobic coatings on vessels would also have a characteristic surface roughness to induce a turbulence near the surface to reduce the drag. Nanomaterials have been proposed for these structures, such a manganese, zinc, magnesium and silicon oxides, and the length scales of the roughness is preferably on the 1-2 micron scale. Despite the interest in hydrophobic and superhydrophobic structures, their durability and the means of formulating the preferred surface roughness has been an impediment to their commercial exploitation. There is a need for a superhydrophobic marine coating formulations to minimise drag. For general applications, such coatings would have to integrate into strategies to reduce fouling and corrosion.

Nano-materials, generally known by regulators as nano-forms, are often bio-active and there is a prior art associated with the use of such bio-active nano-materials in marine antifouling paints. For example, Hikku et. al. in “Nanoporous MgO as self-cleaning and anti-bacterial pigment for alkyd based coating”, Journal of Industrial and Engineering Chemistry http://dx.doi.org/10.1016/j.jiec.2017.03.040 describe the use of bioactive MgO nano-particles in marine antifouling coatings to provide self-cleaning and anti-bacterial properties. More generally, the patent by Loth et. al “Superhydrophobic nanocomposite coating” WO2012/170832A discloses the use of nano-particles to improve the superhydrophobic properties of marine coatings.

In general terms, it would be appreciated by a person skilled in the art that nano-particles are expensive to make and difficult to handle without agglomeration, and it would be desirable to produce materials that have desirable properties of nano-particles but which are powders of a particles of a size greater than 100 nm, which is adopted as the size scale of a nano-particle, produced at scale using powder processing techniques.

Further such nano-particles, are nanoforms that require specific registration in most countries for use in any products because of the human health impacts because nano-particles are breathable and may by adsorbed through the skin. This may impose limitations on their use. There is a need to use materials that have the same bio-activity as nano-particles but are not limited by the health concerns of nano-particles because the particles are >100 nm in dimension.

In this disclosure, such materials are called “nano-active” and the context is that such materials may be use as constituents of marine antifouling paints and anti-corrosive paints without the potential deleterious impact of nano-particles.

Bio-active nano-active materials, and in particular the MgO powers, that have such properties have been described by Sceats and Hodgson in the patent “Powder Formulations for Controlled release of Reactive Oxygen Species” in PCT/AU2019/015107 (incorporated herein by reference) and references therein. These powders have a particle size greater than about 1 micron, and are not nano-articles; and they are not manufactured as composites of nano-particle, but have an internal pore volumetric surface area of greater than 100 m²/cm³ which is about the same exterior volumetric surface area of small nanoparticles,

Any discussion of the prior art throughout the specification should in no way be considered as an admission that such prior art is widely known or forms part of common general knowledge in the field.

### SUMMARY

### Problems to be Solved

The first major problem to be solved is to develop a non-toxic material that can be incorporated into coating formulations to inhibit the growth of tertiary colonisers.

The formulations may be used to completely, or substantially replace the toxic copper materials, and should preferably be able to be directly applied to aluminium substrates (to which certain forms of copper cannot be applied).

The second major problem to be solved is to develop a non-toxic material that can be incorporated into coating formulations to inhibit corrosion (and fouling) when directly applied on steel and aluminium structures.

Additional problems to be solved are to formulate coatings, with the materials for inhibiting the growth of primary and secondary colonisers. This may include combinations of materials that include:
(a) formulations with approved booster biocides, or preferably new non-toxic booster antifoulants that inhibit growth of primary and secondary colonisers on static infrastructure or vessels;
(b) formulations with known booster anticorrosion materials such lanthanides that assist corrosion inhibition;
(c) formulations with polymer materials and additives that make ablative coatings for applications on vessels; and or
(d) formulations with polymer materials and additives that make coatings with superhydrophobic surfaces, and preferably for use in vessels with surfaces that have a roughness to reduce drag.
   The primary advantage of such solutions are to produce formulations that eliminate or minimise the use of toxic materials in marine coatings for static infrastructure and vessels by replacing the key constituents with sustainable materials.

This common approach uses many industrial processes has been to use toxic biocides to kill micro- and macro-organisms that are either pathogens, or inconvenient to efficiency of processes, such as the maritime services and marine transport in this application. This approach is now understood to be time limited by the development of resistance of target organisms to biocides. Thus any particular biocide has an ephemeral impact, and the discovery of new biocides is slowing so that this paradigm is not sustainable. The basis for the approach disclosed in this invention is to change the biome so that the organisms of concern are dissuaded from colonising the applicable environment. In this case, the biome of interest is that which grows on surfaces exposed to sea water, and that is a complex process of colonisation described above.

The present invention described herein may address or ameliorate at least one of the aforementioned applications or advantages.

### Means for Solving the Problem

A first aspect of the present invention may relate to a formulation for a coating for applications on maritime infrastructure or vessels to inhibit fouling and corrosion that comprises: (a) a nano-active material; and (b) a polymer binder; and (c) additives which include pigments, booster antifoulants, booster anticorrosion materials, solvents, polymerisation activators, viscosity modifiers and fillers, where the nano-active material, the binder and additives provide the coating with the desired most desirable properties of antifoul, anticorrosion, adhesion, and strength, required for the coating application.

Preferably, the nano-active material is at least 10 wt %, and 30-75% of the set coating weight depending on the coating application.

Preferably, the nano-active material is a porous powder material with an average particle size in the range of 1-300 microns, which is sufficiently porous with a high pore volume surface area of greater that 100 m²/cm³ comparable to, or exceeding, the external volumetric surface area of nanoparticles with a dimension less than about 100 nm.

More preferably, the nano-active material is a powder material with an average particle size in the range of 4-10 microns, which is sufficiently porous with a high volumetric surface area comparable to, or exceeding, that of nanoparticles with an external volumetric surface area of greater than 100 m²/cm³

Preferably, the nano-active material include nano-active powders with a chemical composition of AgO, ZnO, CuO, Cu₂O, MgO, SiO₂, Al₂O₃, Mn₃O₄ and combinations thereof. Preferably, the chemical purity of these materials are 80% or more; More preferably, the chemical purity of these materials are greater than 95%.

Preferably, the binder is drawn from a wide range of polymer materials, including acrylic, saturated or unsaturated polyester, alkyd, polyurethane or polyether, polyvinyl, cellulosic, silicon-based polymers, co-polymers thereof, and contain reactive groups such as epoxy, carboxylic acid, hydroxyl, isocyanate, amide, carbamate, amine and carboxylate groups, among others, including mixtures thereof. Preferably, combinations of film-forming polymers are used. Preferably, the materials include thermosetting polymers, polymers that require initiators, accelerants, or polymers that set through volatilisation of solvents. Preferably, the selection of the binder and additives are determined to provide a coating which is adhesive to the substrate, hard, ablative, hydrophobic or superhydrophobic as required for the application when combined with the nano-active material.

Preferably, the applications include an inner coating or primer for coating on appropriately prepared steels of various compositions, aluminium, aluminium alloys, zinc-aluminium alloys, clad aluminium, and aluminium plated steel, wherein the substrates comprise more than one metal or metal alloy, in that the substrate is a combination of two or more metal substrates assembled together, such as hot dipped galvanized steel assembled with aluminium substrates; wherein the adhesion of the coating is an important consideration for the selection of the binder and additives, and the corrosion inhibition is an important consideration for selection of the nano-active material, while maintaining the fouling inhibition.

Preferably, in the application, the corrosion properties are enhanced by the addition of booster anticorrosion material such as lanthanide materials, where the materials, including the binding of the booster anticorrosion material to the nano-active material and the binder, are determined to release the anticorrosion materials at a rate to inhibit and repair any corrosion of the substrate.

Preferably, the applications include an outer coating where the fouling inhibition is an important consideration, a selection of the nano-active material with biofoulant properties, and the booster antifoulants which are selected to inhibit the growth of primary, secondary and tertiary foulants.

Preferably, the booster antifoulant is a biocide, and its impact is directed towards the inhibition of primary and secondary foulants through release of the antifoulant into the water at a release rate determined by the dissolution of the antifoulants and the other constituents of the coating, or the ablation of the coating, and the nano-active materials are directed towards inhibition of the tertiary foulants within the coating.

Preferably, the booster antifoulant is bound within the nano-active material.

Preferably, the booster antifoulant is a second nano-active material.

Preferably, for a hydrophobic or superhydrophobic coating for coating a vessel in which the nano-active material, or other additives, spontaneously produces indentations, or the indentations are printed during or after application, where such indentations reduce the hydrodynamic drag of the vessel and the antifouling nano-active material and the booster material inhibit fouling when the vessel is stationary.

Preferably, the indentations regenerates as the coating is worn down by friction.

This core constituent of the invention described herein is nano-active MgO powder described by Sceats and Hodgson, which describe the means of manufacture of the powder through flash calcination. In that invention, the bioactivity of the powder formulations is associated with the production of Reactive Oxygen Species (ROS) which are created when the strained lattice of MgO is hydrated by water. Subsequent work has been carried out and reported, by Andreadelli et.al “Effects of magnesium oxide and magnesium hydroxide microparticle foliar treatment on tomato PR gene expression and leaf microbiome” for agricultural applications that demonstrates the nano-active MgO powder is not a biocide, but acts to change the biome on the plant or animal surface to genera which are aerobic and often dominated by aerobic extremophiles that can tolerate pH in the range of 9-10. The inhibition of pathogens and pests reported is reported in field trials of nano-active MgO sprays on tomatoes by Van Merkestein et. al. in “An evaluation of Booster-Mag™ on processing tomato farming productivity” XV International Symposium on Processing Tomato-XIII World Processing Tomato Congress, 2019. 1233: p. 33-40. It would be obvious to a person skilled in the art that such inhibition can be attributed to the adaptation of the natural leaf biome towards an aerobic biome which inhibits pathogens and pests. Toxicology studies undertaken to demonstrate the use of nano-active MgO as a plant protection product shows that the nano-active MgO powder is non-toxic to animals, and its use in aquaculture by the applicant demonstrates that it is non-toxic to fish.

The Sceats Hodgson patent disclosed the use of nano-active AgO, ZnO, CuO, MgO, SiO₂, Al₂O₃, Mn₃O₄ and mixtures thereof. In the context of marine coatings, the use of nano-active Cu₂O is relevant. For example, it can be produced by the methodology described in that patent by calcining a cuprous salt with a volatile constituent in an inert atmosphere.

Sceats and Hodgson noted that an advantage of that invention may allow the nano-active powder to be deployed in antifouling marine coatings or paints where the primary or secondary colonisers may be the anaerobic bacteria that surround cyprid barnacle larvae as they transition to the sessile stage to first bind to a surface. They noted that premature inhibition of such bacterial colonies on a coated surface may inhibit the attachment of such larvae to such a coated surface. The inventions described herein disclose the formulations of nano-active powders that give effect to that statement, through investigations that have revealed other advantages not disclosed by Sceats and Hodgson.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### DESCRIPTION OF THE INVENTION

Preferred embodiments of the invention will now be described by reference to the non-limiting examples.

The embodiments described herein are marine coating formulations incorporating at least one nano-active oxide material as described by Sceats and Hodgson. Preferably, the formulation for a coating comprises (a) a nano-active material; and (b) a polymer binder; and (c) additives which include pigments, booster antifoulants, booster anticorrosion materials, solvents, polymerisation activators, viscosity modifiers and fillers. It may be appreciated that any type of pigments, booster antifoulants, booster anticorrosion materials, solvents, polymerisation activators, viscosity modifiers or fillers may be used. It has been found by experiment that the nano-active magnesium oxide powder behaves in a formulation similar to a filler, and or a conventional antifoulant, material, so that the established arts of marine coating formulations may be applied by substituting these materials with only minimal changes required to optimise the performance.

The nano-active material, the binder and additives provide the coating with the desired most desirable properties of antifoul, anticorrosion, adhesion, and strength, required for the coating application. The specific examples described use nano-active MgO as the material which describes the material which has the primary impact against tertiary colonisers so that the material may replace in whole or part, of the copper materials that are conventionally used. Preferably, the nano-active material is at least 10 wt %, and 30-75% of the set coating weight depending on the coating application. The nano-active material is a powder material with an average particle size typically in the range of 1-300 microns, which is sufficiently porous with a high volumetric surface area comparable to, or exceeding, that of nanoparticles with a dimension less than 100 nm. It is most preferable that the nano-active material is a powder material with an average particle size typically in the range of 4-10 microns. Other nano-active materials, such as AgO, ZnO, CuO, MgO, SiO₂, Al₂O₃, Mn₃O₄ described by Sceats and Hodgson. The Sceats Hodgson patent disclosed the use of nano-active AgO, ZnO, CuO, MgO, SiO₂, Al₂O₃, Mn₃O₄ in marine coatings. In the context of marine coatings, the use of nano-active Cu₂O is relevant. Embodiments with mixtures of such nano-active materials may be used to optimise the performance of the formulation. The chemical purity of these materials may be 80% or more. Most preferably, the chemical purity of these materials are greater than 95%.

The polymer binder may be drawn from a wide range of polymer materials, including acrylic, saturated or unsaturated polyester, alkyd, polyurethane or polyether, polyvinyl, cellulosic, silicon-based polymers, co-polymers thereof, and contain reactive groups such as epoxy, carboxylic acid, hydroxyl, isocyanate, amide, carbamate, amine and carboxylate groups, among others, including mixtures thereof, wherein combinations of film-forming polymers are used, and wherein the materials include thermosetting polymers, polymers that require initiators, accelerants, or polymers that set through volatilisation of solvents, wherein the selection of the binder and additives are determined to provide a coating which is adhesive to the substrate, hard, ablative, hydrophobic or superhydrophobic as required for the application when combined the with nano-active material.

The applications include an inner coating or primer for coating on appropriately prepared steels of various compositions, aluminium, aluminium alloys, zinc-aluminium alloys, clad aluminium, and aluminium plated steel, wherein the substrates comprise more than one metal or metal alloy, in that the substrate is a combination of two or more metal substrates assembled together, such as hot dipped galvanized steel assembled with aluminium substrates; wherein the adhesion of the coating is an important consideration for the selection of the binder and additives, and the corrosion inhibition is an important consideration for selection of the nano-active material, while maintaining the fouling inhibition. For the primary purpose of corrosion and adhesion, the substrates include, for example, steels of various compositions, aluminium, aluminium alloys, zinc-aluminium alloys, clad aluminium, and aluminium plated steel. Substrates may also comprise more than one metal or metal alloy, in that the substrate may be a combination of two or more metal substrates assembled together, such as hot dipped galvanized steel assembled with aluminium substrates. Surfaces generally have to be prepared before application. Where corrosion inhibition described herein is not used, the substrate may be coated with a conventional anti-corrosion material. Formulations may be described herein that describe a primer for corrosion protection based on nano-active materials. In the application, the corrosion properties are enhanced by the addition of booster anticorrosion material such as lanthanide materials, where the materials, including the binding of the booster anticorrosion material to the nano-active material and the binder, are determined to release the anticorrosion materials at a rate to inhibit and repair any corrosion of the substrate.

A coating may be applied in a number of applications in which the formulation is varied layer by layer, with the binder being chosen to give the desired adhesion. In the example embodiments, the binder may be drawn from a wide range of polymer materials, including acrylic, saturated or unsaturated polyester, alkyd, polyurethane or polyether, polyvinyl, cellulosic, silicon-based polymers, co-polymers thereof, and may contain reactive groups such as epoxy, carboxylic acid, hydroxyl, isocyanate, amide, carbamate, amine and carboxylate groups, among others, including mixtures thereof. Combinations of film-forming polymers can be used. The materials include thermosetting polymers, polymers that require initiators, accelerants, or polymers that set through volatilisation of solvents. Importantly, formulations include common polymers that are used to make hard and ablative coatings through additives. Other additives include pigments, fillers, diluents and viscosity modifiers.

The coating compositions of the present invention may be applied by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, may be used. Many of these techniques are not used in the maritime industry, and the formulations described herein can be applied using conventional techniques used for marine coatings.

The first example embodiment of the present invention is a formulation which comprises as the bioactive material nano-active MgO powder and an aluminium compatible biocide and booster biocide in an ablative formulation. The desirable amounts of nano-active MgO powder are 5-50 wt %, and preferably 25-50% including the biocide and booster biocide. The role of the biocide and booster biocide is to inhibit the growth of primary and secondary colonisers that lay down the biofilms to which the larvae of the tertiary colonisers grow. The biocide inhibit the growth of the tertiary colonisers. The role of the nano-active MgO powder is to firstly further inhibit the growth of the tertiary colonisers by deterring the invasion of the tendrils from the larvae into the bulk of the coating through the release of ROS, and secondly to provide corrosion protection of the substrate, and thirdly to inhibit the of primary and secondary colonisers. The biocide and booster biocide may be materials that are incorporated into the nano-active MgO material by adsorption onto the surface wherein the release rate of the biocide and booster biocide is controlled by the strength of the biding and the dissolution of the nano-active MgO near the surface. It would be recognised by a person skilled in the art that the release of ROS, the release of the biocide and booster biocide, and the ablation rate are factors pertinent to the performance of the coating to minimise fouling, both in selection of the booster biocide, polymer and additive. Other examples of this embodiment include the substitution of the nano-active MgO, in whole or in part, by other nano-active materials where the role of the materials is to inhibit fouling. Given that both the biocide and booster-biocide are toxic, it would be most desirable that the formulation would minimise the use of the biocide and booster biocide, and most desirable that the formulation it would the need for biocide and booster biocide are not required.

Specific example embodiments are given for an ablative coating derived, for example from formulations made from toxic Cuprous Oxide, Cu₂O are shown in Table 1.

TABLE 1

| | Reference Formulation | | Nano-Active Formulations | | | | | |
|---|---|---|---|---|---|---|---|---|
| Constituents | | wt % wet | Example 1 | wt % wet | Example 2 | wt % wet | Example 3 | wt % wet |
| 1° biocide | cuprous | 40-50% | nano-active | 50-60% | nano-active | 35-40% | nano-active | 50-60% |
| | oxide | | MgO | | MgO | | MgO | |
| 2° biocide | thiram | 1-10% | — | | cuprous | 15-20% | nano-actove | 10-20% |
| | | | | | oxide | | ZnO | |
| thinner | n-butanol | 1-20% | n-butanol | 1-20% | n-butanol | 1-20% | n-butanol | 1-20% |
| thinner | xylene | 10-20% | xylene | 10-20% | xylene | 10-20% | xylene | 10-20% |
| binder | rosin | 1-10% | rosin | 1-10% | rosin | 1-10% | rosin | 1-10% |
| pigment | zinc oxide | 10-20% | zinc oxide | 10-20% | zinc oxide | 10-20% | | |
| plasticisers | various | <5% | various | <5% | various | <5% | various | <5% |
| tints | various | <15% | various | <15% | various | <15% | various | <15% |

Similar formulations for ablative coatings may be made using copper isothionate as the reference toxic biocide, for example where the 2^{nd} biocide may be copper isothianate or pyrithione zinc, and the thinners may be mixtures of ethylbenzene and xylene

A further embodiment is a formulation which comprises as the bioactive material nano-active MgO powder and an aluminium compatible biocide such as cuprous oxide and copper isothionate and booster biocide materials, both at reduced rates, in an ablative formulation. The amounts of nano-active MgO powder in the ablative polymer is a direct % w/w direct substitution of the biocide and booster biocide.

The second embodiment of the present invention is a hard coating in which the polymer and non-active additives for an ablative coating, is replaced by a polymer and additives for a hard coating. A further embodiment of this example is a formulation which comprises as the bioactive material nano-active MgO powder and a biocide and booster biocide materials, both at reduced rates. The porous MgO powder allows some penetration by water to activate the ROS.

Further enhancement of either the first and second embodiments with respect to corrosion is where the corrosion rate is inhibited by the addition of a lanthanum material to the composition, and most preferably where the lanthanum ions are bound into the nano-active material so that its release rate is optimised to repair the corrosion. Other “repair” materials may be also be used instead of lanthanum, including any of the lanthanide elements or mixtures thereof. It is noted that corrosion occurs on the substrate when the coating is punctured. Thus this formulation may be applicable to an embodiment for a primer in which the polymer is selected to form a hard coating.

A third embodiment of the present invention is similar to the first embodiment where a fraction of the nano-active powder material is converted to a form that enables the formulation that is superhydrophobic when used with selected polymer systems, which are most likely to be polymers which create hard coatings. The formation of such nano-active superhydrophobic particles may be formed by reaction of the nano-active particles with stearic acid and the like. It is preferable that such a reaction is limited to the surface of the nano-active particle so that the release of ROS for inhibition of fouling and corrosion is not impeded. It would be understood by a person skilled in the art that such desirable properties are established by the properties of the organic chains of the stearate-like materials. An extension of this embodiment is one in which the particle size of the nano-active material is selected to form and maintain an indented structure to minimise drag when applied to a vessel.

It would be appreciated by a person skilled in the art that the formulations disclosed above may be applied as separate coatings. For example, a hard formulation may include an inner coating doped with lanthanum to minimise corrosion, a mid-layer with a formulation to mitigate both corrosion and fouling, and an outer layer to minimise fouling and friction such as a superhydrophobic structure.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrially applicable.

1. A formulation comprising:
(a) a nano-active material comprising a powder material with an average particle size in the range of 1-300 microns, with a volumetric pore surface area greater than 100 m²/cm³; and
(b) a polymer binder; and
(c) additives comprising pigments, booster antifoulants, booster anticorrosion materials, solvents, polymerisation activators, viscosity modifiers and fillers; wherein the booster anticorrosion materials comprise lanthanide material;
wherein the mixture of the nano-active material, the binder and the additives provides an antifouling and anticorrosion coating to maritime infrastructure or vessels, when applied.

2. The formulation of claim 1, wherein the nano-active material is at least 10 wt %, and 30-75% of the set coating weight depending on the coating application.

3. The formulation of claim 1, wherein the nano-active material is a powder material with an average particle size typically in the range of 1-300 microns, which is sufficiently porous with a volumetric pore surface area greater than 100 m²/cm³.

4. The formulation of claim 3, wherein the nano-active material is a powder material with an average particle size typically in the range of 4-10 microns.

5. The formulation of claim 3, wherein the nano-active materials include nano-active powders with a chemical composition of AgO, ZnO, CuO, Cu₂O, MgO, SiO₂, Al₂O₃, Mn₃O₄ and combinations thereof.

6. The formulation of claim 5, wherein the chemical purity of these materials is 80% or more.

7. The formulation of claim 6, wherein the chemical purity of these materials is greater than 95%.

8. The formulation of claim 1, wherein the polymer binder is drawn from a wide range of polymer materials, including acrylic, saturated or unsaturated polyester, alkyd, polyurethane or polyether, polyvinyl, cellulosic, silicon-based polymers, co-polymers thereof, and contain reactive groups such as epoxy, carboxylic acid, hydroxyl, isocyanate, amide, carbamate, amine and carboxylate groups, among others, including mixtures thereof, wherein combinations of film-forming polymers are used, and wherein the materials include thermosetting polymers, polymers that require initiators, accelerants, or polymers that set through volatilisation of solvents, wherein the selection of the binder and additives are determined to provide a coating which is adhesive to the substrate, hard, ablative, hydrophobic or superhydrophobic as required for the application when combined the with nano-active material.

9. The formulation of claim 8, wherein the applications include an inner coating or primer for coating on appropriately prepared steels of various compositions, aluminium, aluminium alloys, zinc-aluminium alloys, clad aluminium, and aluminium plated steel, wherein the substrates comprise more than one metal or metal alloy, in that the substrate is a combination of two or more metal substrates assembled together, such as hot dipped galvanized steel assembled with aluminium substrates; wherein the adhesion of the coating is an important consideration for the selection of the binder and additives, and the corrosion inhibition is an important consideration for selection of the nano-active material, while maintaining the fouling inhibition.

10. The formulation of claim 9, wherein in the application, the corrosion properties are enhanced by the addition of booster anticorrosion material such as lanthanide materials, where the materials, including the binding of the booster anticorrosion material to the nano-active material and the binder, are determined to release the anticorrosion materials at a rate to inhibit and repair any corrosion of the substrate.

11. The formulation of claim 1, wherein the applications include an outer coating where the fouling inhibition is an important consideration, a selection of the nano-active material with biofoulant properties, and the booster antifoulants which are selected to inhibit the growth of primary, secondary and tertiary foulants.

12. The formulation of claim 1, wherein the booster antifoulant is a biocide, and its impact is directed towards the inhibition of primary and secondary foulants through release of the antifoulant into the water at a release rate determined by the dissolution of the antifoulants and the other constituents of the coating, or the ablation of the coating, and the nano-active materials are directed towards inhibition of the tertiary foulants within the coating.

13. The formulation of claim 12, wherein the booster antifoulant is bound within the nano-active material.

14. The formulation of claim 12, wherein the booster antifoulant is a second nano-active material.

15. The formulation of claim 1 for a hydrophobic or superhydrophobic coating for coating a vessel in which the nano-active material, or other additives, spontaneously produces indentations, or the indentations are printed during or after application, where such indentations reduce the hydrodynamic drag of the vessel and the antifouling nano-active material and the booster material inhibit fouling when the vessel is stationary.

16. The formulation of claim 15, in which the indentations regenerates as the coating is worn down by friction.
